(19) United States
(12) Patent Application Publication
(10) Pub. No.: US 2011/0129742 A1
(43) Pub. Date: Jun. 2, 2011

(54) Nonequilibrium Chemovoltaic Fuel Cell

(75) Inventor: Eduard Karpov, Glenview, IL (US)

(73) Assignee: The Board of Trustees of the University of Illinois, Urbana, IL (US)

(21) Appl. No.: 13/055,387

(22) PCT Filed: Jul. 31, 2009
(86) PCT No.: PCT/US09/52342

§ 371 Date: Jan. 21, 2011

Related U.S. Application Data
(60) Provisional application No. 61/085,033, filed on Jul. 31, 2008.

(51) Int. Cl. H01M 8/06; H01M 4/02; H01M 4/58; H01M 4/38; H01M 8/22; H01M 8/24

(52) U.S. Cl. 429/414; 429/532; 429/524; 429/525; 429/527; 429/413; 429/505; 429/452

(57) ABSTRACT

A chemovoltaic cell converts chemical energy generated by an in-situ molecular hydrogen oxidation reaction into electrical energy by creating a chemically induced nonequilibrium electron population on a catalytic surface of a Schottky structure, followed by charge separation and electric power generation using the Schottky contact.

### FIELD OF THE INVENTION

This invention generally relates to fuel cells, and in particular to a chemical-to-electrical energy converting fuel cell.

### BACKGROUND OF THE INVENTION

With the arrival of high-performance mobile electronic devices, and increased interest in green vehicle concepts, a great research effort has been undertaken for the development of efficient solid-state power generators, including hydrogen and methanol fuel cells, and thermoelectric generators. Practically, a high cost and a limited lifetime of fuel cells, and low efficiency of thermoelectric generators limit their implementation.

Hydrogen fuel cells (HFC) provide high hopes for a sustainable future for energy systems. They are considered an integral segment of the hydrogen economy cycle, which can produce the cleanest chemical fuel through hydrogen burning, wherein electric power is generated without any moving parts for transportation vehicles and portable electronic devices. Large scale cells can be used for stationary applications and can serve as a key element of the future photocatalysis energy plants, utilizing solar power for the catalytic dissociation of water into the gaseous hydrogen and oxygen components.

Some of the most notable drawbacks limiting the desired functionality of the current fuel cells are low power-to weight ratio, high temperature operation, and short lifetimes. One general scientific reason for these drawbacks is the intrinsic equilibrium nature of the device physics including a thermal equilibrium of the electron subsystem with the host electrode material. That is, the hydrogen fuel cell operates, in principle, as a common electrochemical cell such as alkaline, lithium, etc. The only notable difference between the hydrogen fuel cell and the common electrochemical cell may be that the hydrogen fuel cell uses the external supply of the chemical fuel and oxidant, while they are internally stored in case of the common electrochemical cell.

Light energy converting cells such as the Schottky barrier solar cells are also known in the industry. The Schottky barrier cells comprise metal-semiconductor barriers in place of p-n junctions, to convert light energy such as sunlight to electrical energy. An example of the Schottky cell is disclosed in U.S. Pat. No. 4,278,830; and PCT Patent Publication No. WO 03/012880 A2, the entire disclosures of which are hereby incorporated by reference.

It is desirable, therefore, to provide an improved fuel cell and method of converting energy which overcomes one or more of the problems discussed above, and/or provide improved utility over the prior art.

### BRIEF SUMMARY OF THE INVENTION

A new class of chemical to electrical energy converter, chemovoltaic fuel cell, which can greatly outperform the existing hydrogen fuel cells in both efficiency and power density is provided. The chemovoltaic fuel cell, according to the present invention, creates a chemically induced nonequilibrium electron population on catalytic solid surfaces, followed by charge separation and electric power generation by means of an intrinsic barrier junction providing a Schottky contact. The metal semiconductor nanostructures, wherein an in situ exothermic chemical reaction on the metallic cathode provides higher efficiencies.

A Pd/n-SiC heterojunction nanostructure including a nano thickness metal layer, according to an embodiment of the present invention, can be utilized for an efficient conversion of the energy from the catalytic 2H₂+O₂→2H₂O process into electric current. Occurrence of this current is explained by the internal emission of hot electrons from the metallic cathode, which also serves as a catalyst for the reaction, into the semiconductor layer over the Schottky barrier. Along with the usual thermionic emission current related to the thermal excitation of the hot electrons, there is another significant and sometimes dominant component to the current owed to the direct (non-adiabatic) transfer of the chemical energy to the electronic subsystem of the metal. As a result, the catalothermionic power generator, according to an embodiment of the present invention, can reach an internal quantum yield of electrons per one exhaust water molecule of about 0.20 at elevated surface temperatures of the metallic cathode layer.

One inventive aspect is a chemovoltaic cell for converting a chemical energy to an electrical energy. The chemovoltaic cell includes a semiconductor layer, a catalyst metal layer attached to the semiconductor layer and a metallic layer attached to the semiconductor layer. A junction between the catalyst metal layer and the semiconductor layer forms a Schottky contact and the metallic layer provides an Ohmic contact. The catalyst metal layer of the chemovoltaic cell has a dual role in the chemovoltaic cell. The catalyst metal layer is a catalyst for an in-situ exothermic chemical reaction, which catalyzes the chemical reaction on a surface of the catalyst metal layer to generate a chemical energy. The catalyst metal layer is also an emitter, wherein the chemical energy induces nonequilibrium electron population in the catalyst metal layer, wherein the catalyst metal layer generates and emits hot electrons over the Schottky barrier to the semiconductor layer and toward the metallic layer. As such, a combination of the catalyst metal layer, the semiconductor layer and the metallic layer converts the chemical energy into the electrical energy.

The chemovoltaic cell according to some embodiments of the present invention can use molecular hydrogen as a fuel and oxygen or air as oxidant, wherein the catalyst metal layer catalyzes a hydrogen oxidation reaction, 2H₂+O₂→2H₂O, which produces a water vapor and the chemical energy. The semiconductor layer can be a n-type or a p-type. The catalyst layer can be formed of Pt, Pd, Ni, Ag, Au, or Ir to have a nanoscale thickness between about 7 nm-25 nm. In one embodiment, the catalyst metal layer is formed of Pd in a thickness between 8 nm-15 nm; the semiconductor is formed of a n-type SiC-6H; and the metallic layer is formed of In. The Pd catalyst metal layer receives a stoichiometric oxyhydrogen mixture and catalyzes a hydrogen oxidation reaction to generate a chemical energy, which is used to generate hot electrons at a quantum yield of about 0.2, wherein the quantum yield is a mean number of hot electrons generated in the catalyst metal layer with sufficient energy to overcome the Schottky barrier, which are collected by busbars, as a result of production of one water molecule on the surface of the catalyst metal layer.

The chemovoltaic cell is configured to generate hot electrons or hot holes both adiabatically and non-adiabatically, such that at least some chemical energy released from the in-situ chemical reaction is directly transferred to an electron subsystem of the catalyst metal layer to generate non-adiabatic hot electrons or hot holes. In some embodiments, the non-adiabatic hot electrons comprise over 70% of the hot electrons generated and emitted by the catalyst metal layer.

The chemovoltaic cell can be configured to have a layered morphology, wherein the semiconductor layer is sandwiched between the catalyst metal layer and the metallic layer, or a single-sided morphology, wherein the catalyst metal layer and the metallic layer are on a same side of the semiconductor layer.

Another aspect of the invention is a method of converting a chemical energy into an electrical energy. The method includes steps of providing a chemovoltaic cell having a catalyst metal layer and a metal layer on a semiconductor layer, supplying reactants on a surface of the catalyst metal layer, catalyzing a chemical reaction of the reactants using the catalyst metal layer to generate a chemical energy, energizing electrons in the catalyst metal layer using the chemical energy to generate hot electrons, and emitting hot electrons from the catalyst metal layer toward the semiconductor layer over a Schottky barrier to generate an electrical current. The catalyst metal layer and the semiconductor layer forms the Schottky barrier, and the metal layer and the semiconductor layer forms an Ohmic contact.

In one preferred embodiment, the method uses a stoichiometric oxyhydrogen mixture as reactants. The catalyst metal layer catalyzes a hydrogen oxidation reaction of the stoichiometric oxyhydrogen mixture to produce the chemical energy. In one implementation, the chemovoltaic cell is provided by forming the semiconductor layer comprising a n-type SiC-6H substrate having a polished side and a nonpolished side, depositing a continuous layer of Pd on the polished side of the semiconductor layer to form the catalyst metal layer having a thickness between 8 nm-15 nm, and infusing In on the nonpolished side of the semiconductor layer to form the metal layer. The chemovoltaic cell is placed in a vacuum chamber, wherein the stoichiometric oxyhydrogen mixture is supplied into the vacuum chamber in an amount of at least 0.05 Ton at a temperature between about 600K-700K to generate hot electrons or hot holes at a quantum yield of about 0.2.

In the method of converting a chemical energy into an electrical energy, the catalyst metal layer catalyzes a hydrogen oxidation reaction, wherein molecular hydrogen is used as fuel and oxygen gas or air is used as an oxidant, to generate a chemical energy. The chemical energy is used to generate hot electrons in the catalyst metal layer both adiabatically and non-adiabatically, wherein at least a portion of the chemical energy is directly transferred into an energy of excitation of electron subsystem of the catalyst metal layer to generate the hot electrons non-adiabatically. Preferably, at least 70% of the hot electrons are generated non-adiabatically.

Another aspect of the invention is a method of generating electrical energy. The method includes providing a chemovoltaic cell having a catalyst metal layer and a metal layer on a semiconductor layer, supplying a molecular hydrogen and oxygen on the catalyst metal layer, catalyzing a 2H₂+O₂→2H₂O reaction of the molecular hydrogen and oxygen to produce a chemical energy using the catalyst metal layer, and emitting hot electrons induced by the chemical energy in the catalyst metal layer over a Schottky barrier formed by the catalyst layer and the semiconductor layer. Preferably, the chemovoltaic cell is formed by depositing a catalyst metal layer on a surface of the semiconductor layer in a thickness between 5 nm-30 nm. The method can further include generating electrical energy at a quantum yield of about 0.2 at an operating temperature of about 667 K.

Another aspect of the invention is a chemovoltaic battery including a chamber having a gas inlet and a gas outlet; a plurality of chemovoltaic cells arranged in the chamber, wherein each of the plurality of chemovoltaic cells includes a semiconductor layer, a catalyst metal layer attached to the semiconductor layer, wherein a junction between the catalyst metal layer and the semiconductor layer provides a Schottky barrier, a metallic layer attached to the semiconductor layer providing an Ohmic contact The catalyst metal layer catalyzes a chemical reaction and emits hot electrons.

Another aspect of the invention is a chemoelectrical power generator including a n-type chemovoltaic cell having a first catalyst metal layer and a first metal layer on a n-type semiconductor layer; a p-type chemovoltaic cell having a second catalyst metal layer and a second metal layer on a p-type semiconductor layer and a junction connecting the n-type chemovoltaic cell and p-type chemovoltaic cell. The first catalyst metal layer and the second catalyst metal layer catalyze a hydrogen oxidation reaction to produce a chemical energy, and a combination of the n-type chemovoltaic cell and the p-type chemovoltaic cell converts the chemical energy into an electrical energy.

In all of the aspects of the invention discussed above, the catalyst metal layer has a nanoscale thickness. For example, the catalyst metal layer can be formed of Pt having a thickness between 7-10 nm, Pd having a thickness between 8-15 nm, Ni having a thickness between 8-15 nm, Au having a thickness between 10-25 nm, or Ag having a thickness between 10-25 nm.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic cross sectional view of a chemovoltaic cell having a layered morphology including a semiconductor layer between metallic layers according to an embodiment of the present invention;

FIG. 2 is a perspective and an exploded partial schematic view of a chemoelectrical power generator including a layered morphology chemovoltaic cell comprising a Pd/n-SiC heterojunction nanostructure according to an embodiment of the present invention;

FIG. 3 is a graph showing a temperature dependent chemicurrent generation by the chemoelectrical power generator of FIG. 2 using various gases;

FIG. 4 is a graph showing a temperature dependent thermocurrent, which is purely induced by heat, generated by the chemoelectrical power generator of FIG. 2;

FIG. 5 is a graph of mass-spectrometry measurements showing an increase in water vapor pressure during the process of generating the chemicurrent by the chemoelectrical power generator of FIG. 2 using the stoichiometric oxyhydrogen gas mixture;

FIG. 6 is a graph showing a temperature dependent internal quantum yield of the chemoelectrical power generator of FIG. 2;

FIG. 7 is a schematic view of a chemoelectrical power generator including a joint assembly of n-type cell and p-type cell according to an embodiment of the present invention;

FIG. 8 is a perspective view of a chemovoltaic cell having a Schottky contact metal layer and a Ohmic contact metal layer on a same surface of a p-type semiconductor according to a different embodiment of the present invention; and

FIG. 9 is a schematic illustration of a chemovoltaic battery including a plurality of chemovoltaic cells according to an embodiment of the present invention;

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

An energy efficient chemovoltaic cell including a metal-semiconductor nanostructure, which is energized by an in situ exothermic chemical reaction is provided. A chemoelectrical power generator according to an embodiment of the present invention includes the chemovoltaic cell, which converts a chemical energy generated from a catalytic oxidation of molecular hydrogen on a surface of the metallic layer into electrical energy. The chemoelectrical power generator can provide a significantly higher quantum efficiency when compared to similarly configured thermionic power generators, wherein current is thermally induced by externally supplied heat.

A thermionic power generator including metal-semiconductor (Schottky) nanostructures can provide an improved energy efficiency over that of prior thermoelectric generators. The thermionic power generator is based on the phenomenon of internal emission of hot electrons (with energies above Fermi level) from an externally heated metallic cathode over the potential barrier and toward a cold semiconductor anode. The electrons then return to the cathode via an external circuit, where they perform useful work. Advantages of the thermionic generators are longer lifetimes, similar to thermoelectric devices, potentially a high energy density, high robustness and reliability. Furthermore, their efficiency can potentially be greater than the efficiency of the thermoelectric cells utilizing solely the Seebeck effect, owing to the ability of the Schottky heterojunction to selectively maintain ballistic transport of hot electrons over the barrier and scatter lower energy electrons.

The possibility of hot electron generation and emission over the Schottky barrier has been shown recently for surface adsorption of simple radicals (H, O, CO) obtained from high-frequency plasma. However, these processes require an external energy source, and they are not usable to maintain generation of stationary current in the nanostructure. Also, usage of silicon-based structures limits the upper working temperature of the device.

Further, induction of electric current can occur in open semiconductor heterojunction structures during surface chemisorption of active chemical radicals from the gas phase (H, O, CO, etc.), due to generation of nonequilibrium charge carriers (e-h pairs) at the expense of the heat of chemisoption and of simple recombination processes, such as H+H→H₂ and O+O→O₂.

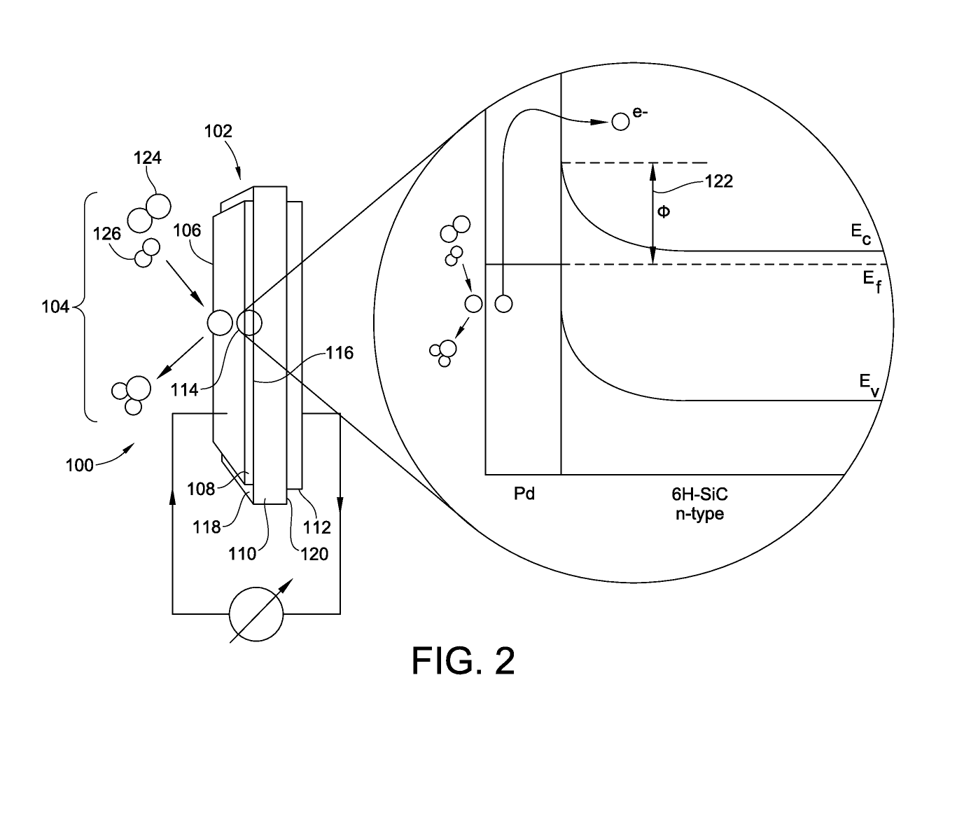

The chemovoltaic cell comprising the metal-semiconductor nanostructures providing a Schottky barrier according to an embodiment of the present invention further improves a power generation efficiency by using an in situ exothermic chemical reaction, such as 2H₂+O₂→2H₂O, on a metallic cathode to supply chemical energy. Such a chemical reaction can lead to both adiabatic and non-adiabatic processes of dissipation of the released chemical energy. The adiabatic processes are manifested simply by heat, while the non-adiabatic ones are related to a direct transfer of the chemical energy to the electron subsystem of the solid and revealed by the excitation and ballistic transport of hot electrons in metals. Thus, the surface chemical reaction does not only serve as a source of heat, but can also enhance the electron flow from metal to semiconductor over the Schottky barrier (FIG. 2). This is because the non-adiabatic processes of chemical energy conversion can provide an additional component to supplement the usual thermally initiated current. The metallic cathode in such a chemovoltaic cell has catalytic activity in relation to the chosen chemical reaction, therefore, the chemovoltaic cell is also referred to as a catalothermionic power generator in this application. The term “catalothermionic” also reflects the adiabatic and non-adiabatic double-channel energy conversion of the present invention. The chemovoltaic cell is also referred to as a chemical to electrical energy converter, a chemoelectrical power generator, or other similar terms in this application.

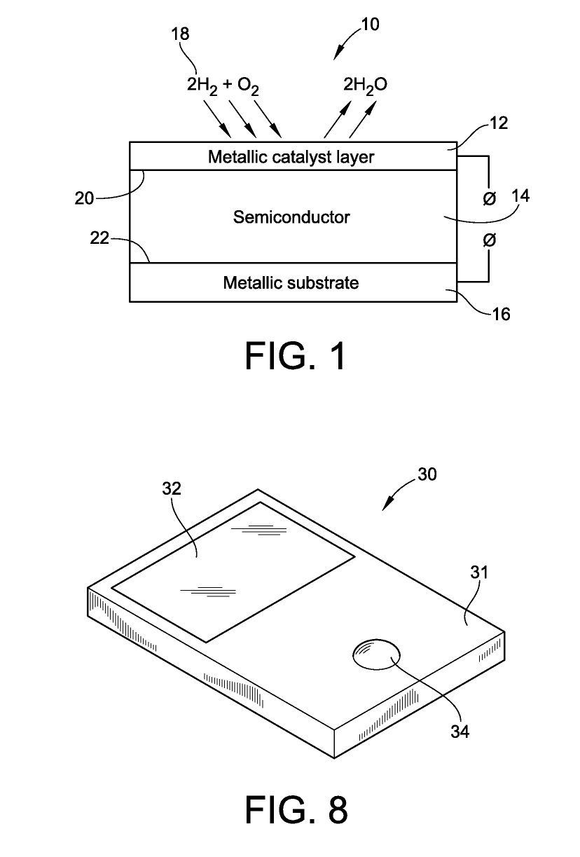

FIG. 1 illustrates an embodiment of a chemovoltaic cell 10 according to an embodiment of the present invention. The chemovoltaic cell 10 comprises a metallic catalyst layer 12, a semiconductor layer 14 and a metallic substrate layer 16. A Schottky contact 20 is formed between the metallic catalyst 12 and the semiconductor 14, and an Ohmic contact 22 is formed between the semiconductor 14 and the metallic substrate 16.

In this embodiment, chemically induced electron-hole pairs can be produced and an electromotive force can be generated during both surface adsorption and recombination processes, provided that the corresponding energy requirements are satisfied. Electric current can be produced in an open heterojunction structure of the chemovoltaic cell 10 by organizing a multistage chemical reaction on its surface. The multistage chemical reaction can include reagents which are stable in the gas phase, such as molecular hydrogen and oxygen that are not dissociated. An example of such chemical reaction is hydrogen oxidation 18, which is known to be the cleanest exothermal chemical process. Although hydrogen oxidation 18 is utilized in this embodiment, other embodiments may involve other suitable chemical reactions.

The semiconductor 14 may be a n-type or a p-type and is coated by a chemically stable metallic catalyst layer 12. The semiconductor surface, in general, is not a good catalyst for the hydrogen oxidation. For example, using luminescence methods, Y₂O₃ doped with Eu (0.1%) has a quantum yield of about 0.0001% per H₂O molecule. Furthermore, most semiconductor surfaces degrade in oxygen atmosphere. Therefore, the metallic catalyst layer 12 on the semiconductor 14 can significantly improve the hydrogen oxidation process and provide a barrier layer to minimize degradation of the semiconductor surface.

The chemovoltaic cell 10 comprising the metallic catalyst layer 12 and semiconductor 14 has a planar Schottky diode architecture, rather than a p-n junction structure, wherein the top metallic catalyst layer 12 forms a barrier layer junction with the semiconductor 14, and also serves as a catalyst for the reaction of hydrogen oxidation. The chemovoltaic cell 10 has a similar architecture as the Schottky photovoltaic cells, but the chemovoltaic cell 10 uses a chemical form of energy rather than an optical/radiative form of energy. Therefore, the chemovoltaic cell 10 having a solar cell like morphology can provide new opportunities for fast adaptation of the well developed conventional photovoltaics manufacturing technologies for the production of the chemovoltaic cells enabling a dual utility purpose of hydrogen and solar.

Unlike the photovoltaic cells, the chemovoltaic cell 10 is only excited in a few atomic layers of the surface, and thus, the chemically induced charge carriers are hot electrons in metal, rather than e-h pairs in semiconductors. Conventionally, individual hot electrons are known as very short living species, relaxing within 10⁻⁴ second by emitting photons. However, in the chemovoltaic cell 10, nonequilibrium electron population in noble metals can lead to a ballistic electron transport without scattering.

In this embodiment, hydrogen oxidation 18 takes place on a surface of the metallic catalyst layer 12. Preferably, the metallic catalyst layer 12 has a thickness smaller than a mean free path of the hot electrons (i.e. nanoscale), such that the hot electrons can successfully overcome the potential barrier at the Schottky junction 20 and appear at the semiconductor side 14 (n-type) of the chemovoltaic cell 10 with a reduced kinetic, but increased potential energy. The hot electrons then diffuse toward the Ohmic contact area 22 and into an external electric circuit.

The metallic catalyst layer 12 can be formed of any suitable chemically stable metallic material, such as palladium (Pd), platinum (Pt), nickel (Ni), iridium (Ir), gold (Au) and silver (Ag). The mean free path of a ballistic electron in such a metal is estimated to be on the order of tens of nanometers. Thus, the metallic catalyst layer 12 can be formed to have a thickness between about 1 nm-100 nm, preferably between about 7 nm-25 nm. In one embodiment, the metallic catalyst layer 12 is formed of Pt having a thickness between 7 nm-10 nm. In a different embodiment, the metallic catalyst layer 12 is formed of Pd having a thickness between 8 nm-15 nm. Yet in a different embodiment, the metallic catalyst layer 12 is formed of Ni having a thickness between 8 nm-15 nm. In another embodiment, the metallic catalyst layer 12 is formed of Ag having a thickness between 10 nm-25 nm. In a different embodiment, the metallic catalyst layer 12 is formed of Au having a thickness between 10 nm-25 nm.

The chemovoltaic cell 10 can directly convert chemical energy into electrical energy, without resorting to heat. Although not necessary, heat generated as a byproduct can facilitate performance of the chemovoltaic cell 10 via thermoelectric effect, similar to solar cells, if chilling for the cell bottom side is provided. The byproduct heat may also be utilized to maintain elevated operating temperatures of the chemovoltaic cell 10, where such elevated operating temperatures are associated with improved performance. In other embodiments, a similar process can take place for chemically induced hot holes, provided that a p-type semiconductor is utilized.

In one embodiment, the metallic catalyst layer 12 comprising Pd can provide for a low operating temperature, since Pd is a catalyst having the highest chemical affinity with hydrogen. The chemovoltaic cell 10 can provide a superior efficiency and power density due to the relatively narrow spectrum of energy quanta produced as a result of the surface chemical reaction. Very high power densities can be produced using a high temperature semiconductor such as SiC.

FIG. 8 illustrates a chemovoltaic cell 30 according to a different embodiment of the present embodiment. As it was with the chemovoltaic cell 10, the chemovoltaic cell 30 includes a semiconductor layer 31, a metallic catalyst layer 34 providing a Schottky contact, and a metallic layer 32 providing an Ohmic contact. However, unlike the chemovoltaic cell 10, which has a layered morphology, wherein the semiconductor layer 14 is sandwiched between the metallic catalyst layer 12 and the metallic substrate layer 16, the metallic layers 32, 34 of the chemovoltaic cell 30 are both on a same side of the semiconductor layer 31.

In this embodiment, the semiconductor layer 31 is formed of a p-type SiC. However, the semiconductor 31 may also be formed of a n-type SiC as it was with the semiconductor layer 14. The metallic layer 32 and the metallic layer 34, which is also a catalyst layer, can be formed of any suitable metallic material. In this embodiment, both metallic layer 32, 34 are formed of Ni. However, the metallic layers 32, 34 may be formed of different metallic materials in other embodiments. The metallic layer 34 acts as a hot electron emitter and also catalyzes a chemical reaction, which supplies the chemical energy to the chemovoltaic cell 30. In this embodiment, molecular hydrogen is used as a fuel with oxygen or air as oxidant for 2H₂+O₂→2H₂O reaction. The catalyst metallic layer 34 can be formed of Ni having a thickness between about 1 nm-100 nm, preferably between 5 nm-25 nm, more preferably between 8-15 nm. The nano-thickness metallic catalysts layer 34 can improve efficiency of a chemicurrent generation substantially.

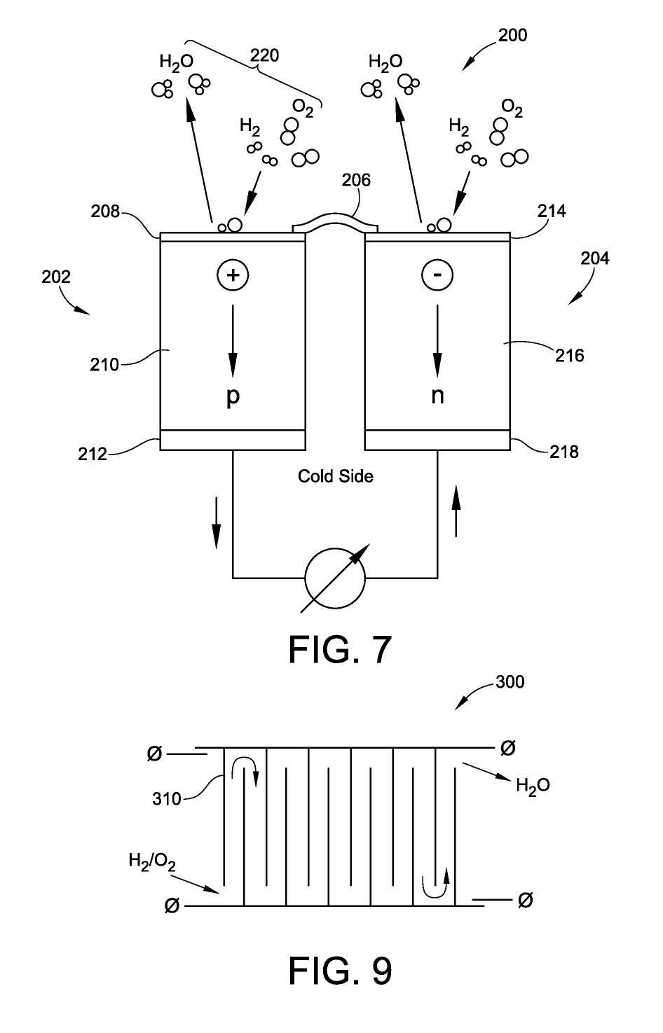

FIG. 7 shows a chemoelectrical power generator 200 having a p-n pillar structure according to one embodiment of the present invention. The chemoelectrical power generator 200 includes a p-type chemovolatic cell 202 and a n-type chemovoltaic cell 204 connected by a junction 206. The p-type chemovoltaic cell 202 includes a metallic catalyst layer 208, a p-type semiconductor layer 210, and a metallic layer 212. Similarly, the n-type chemovoltaic cell 204 includes a metallic catalyst layer 214, a n-type semiconductor layer 216, and a metallic layer 218. As it was with the chemovoltaic cells of other embodiments discussed above, the metallic catalyst layers 208, 214 provide a Schottky contact and catalyze a hydrogen oxidation reaction 220, which supplies the chemical energy for the chemoelectrical power generator 200.

As it was with the chemovoltaic cell 10, the n-type chemovoltaic cell 204 uses the chemical energy released from the hydrogen oxidation reaction 220 to generate hot electrons in the catalyst metallic layer 214. In contrast to the n-type chemovoltaic cell 204, the p-type chemovoltaic cell 202 relies on the ballistic transport of hot holes from the catalyst metal layer 208 over the Schottky barrier and toward the semiconductor layer 210 to provide a reverse voltage. This phenomenon is a reverse perception of transport of energetic electrons from the p-type semiconductor layer 210 over the Schottky barrier and toward the metallic catalyst layer 208, wherein the electrons recombine with chemically induced electron vacancies in the metallic catalyst layer 208, thereby finalizing the process of the ballistic transport of hot holes. The joint assemblies of n-type chemovoltaic cell and p-type chemovoltaic cell can be manufactured as p-n pillar structures, similar to thermoelectric battery assemblies, but powered by the in-situ process of catalytic hydrogen oxidation, as shown in FIG. 7.

FIG. 9 illustrates a chemovoltaic battery assembly 300 according to a different embodiment of the present invention. The chemovoltaic battery assembly 300 includes a plurality of the chemovoltaic cell 310 arranged as a repetitive “comb” structure allowing a simple, but versatile batteries assembly.

Now that some general contemplated chemovoltaic cells have been described, more particular examples of the chemovoltaic cell 10 will be described.

### Example

FIG. 2 shows a chemoelectrical power generator 100 including a chemovoltaic cell 102, which is a Pd/n-SiC heterojunction nanostructure according to an embodiment of the present invention. The chemoelectrical power generator 100 includes a Pd metal layer 108, a SiC semiconductor layer 110, and an Indium (In) Ohmic contact layer 112. In this embodiment, internal electron emission is induced by a hydrogen oxidation to water reaction (2H₂+O₂→2H₂O) 104 on a surface 106 of a Pd/n-SiC heterojunction nanostructure 102.

The Pd metal nanolayer 108 serves both as a reaction catalyst and an emitter of hot electrons 114 traveling over a Schottky barrier 116 toward the semiconductor anode 110. The in situ chemical process provides a significantly higher output of hot electrons when compared to devices with externally heated cathodes. This is because a large fraction of the hot electrons is generated non-adiabatically to complement the usual thermal excitation, leading to a very high total internal quantum efficiency of the device, reaching about 0.20 for the nanostructure 102. Further, the SiC semiconductor layer 110 having a wide bandgap allows for elevated working temperatures leading to natural catalytic oxidation of molecular hydrogen on the Pd metal layer 108, and therefore to a self-sustained regime of electric current generation. In this embodiment, the reaction of hydrogen oxidation has been chosen as a supplier of chemical energy, as the hydrogen reaction is of a great practical interest for the alternative energy research and hydrogen economy perspectives. However, other suitable exothermic reactions can also be used to supply the chemical energy for the chemoelectrical power generator 100.

In one embodiment, the chemoelectrical power generator 100 including the Pd/n-SiC heterojunction nanostructure 102 of FIG. 2 was manufactured by depositing a continuous layer of Pd 108 having a thickness of about 15 nm onto a polished side 118 of a n-type SiC-6H (0001) substrate 110 having a size of about 10×10×0.3 mm³ and a resistivity of about 0.076 Ωcm. The Pd film (0.9999) was deposited using an e-beam deposition in a high vacuum (<10⁻⁷ Torr) at a rate of about 0.015 Å/s and a substrate temperature of about 370 K to form the metal layer 108. The metallic layer 112, which provides an Ohmic contact, was applied in a size of 95 mm² to the reverse non-polished side 120 of the SiC substrate 110 by thermal infusion of pure In (indium) at about 500 K.

In this example, the chemically induced current in the chemoelectrical power generator 100 was measured with a 10 kΩ input impedance nanohmmeter. The chemoelectrical power generator 100 had an essentially non-linear voltage-current characteristic, and about 0.65 eV barrier height 122. The measurements were taken in a 4.5 liter vacuum chamber (not shown) preliminary evacuated to residual pressures of about less than 10⁻⁶ Torr. Working gases were admitted to the analytical chamber diffusively by small portions resulting in pressures of about 0.2 Torr.

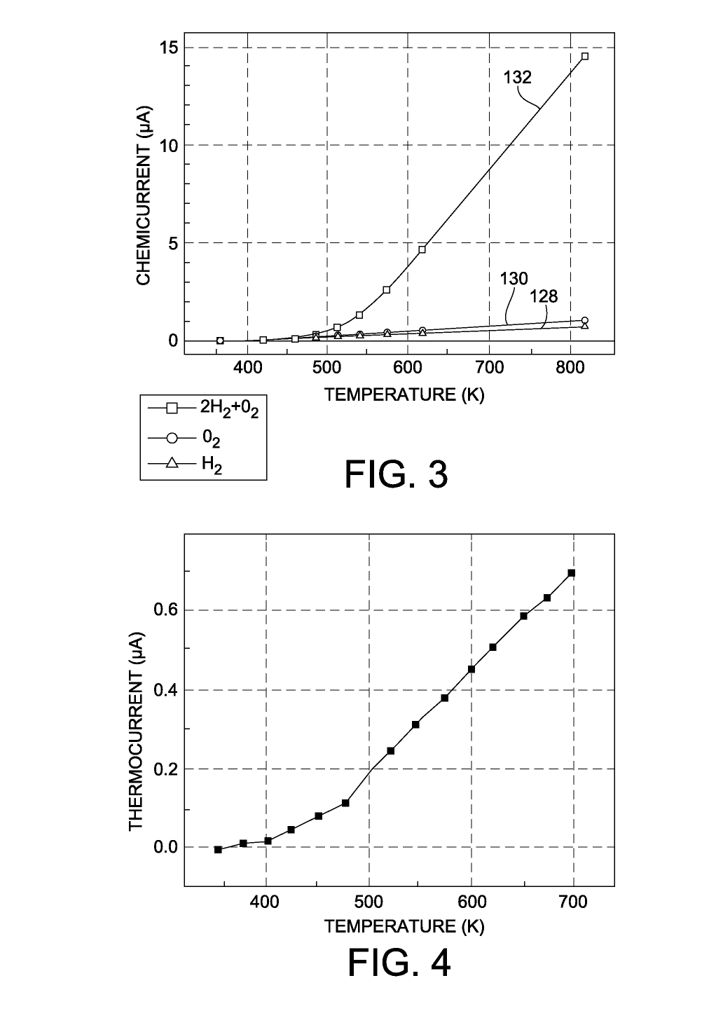

In one implementation, H₂ gas was supplied into the vacuum chamber containing the Pd/n-SiC heterojunction nanostructure 102. In the vacuum chamber, H₂ gas comes in contact with the Pd/n-SiC heterojunction nanostructure 102, which leads to the generation of electric current. This current is a result of adsorption of gas molecules on the metallic surface 106 of the Pd/n-SiC heterojunction nanostructure 102. The current generated in such a method is also referred to as a chemicurrent in this application. The chemicurrent of this embodiment shows maximal values during the first few seconds of the gas admission. The chemicurrent magnitude increases with a surface temperature of the Pd/n-SiC heterojunction nanostructure 102, reaching a value of about 0.74 μA for H₂ at T=667 K as shown by a curve 128 of FIG. 3. Alternatively, the chemicurrent can also be generated by supplying O₂ gas into the vacuum chamber instead of H₂ gas. The temperature dependency of the chemicurrent generation for O₂ gas is shown by a curve 130 of FIG. 3. As shown, the chemicurrent magnitude increases with the temperature, reaching a value of about 0.87 μA at T=667 K.

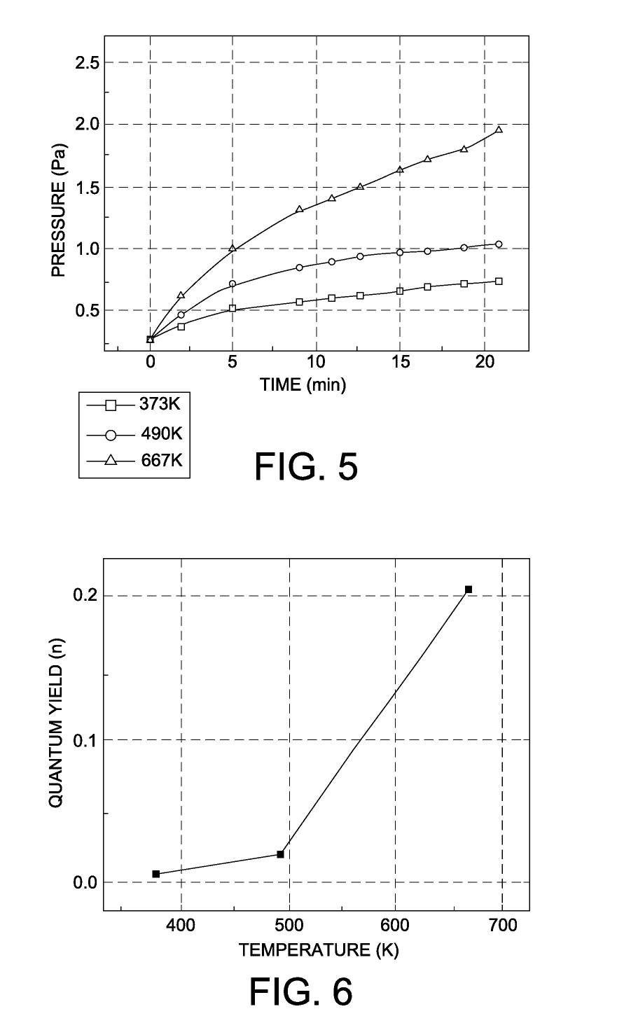

A significantly more current can be generated by supplying a stoichiometric oxygen and hydrogen (oxyhydrogen) mixture. As shown by a curve 132 of FIG. 3, the chemicurrent in the amount of about 7.2 μA was generated at T=667 K by supplying the stoichiometric oxyhydrogen mixture, 2H₂+O₂, into the vacuum chamber containing the Pd/n-SiC heterojunction nanostructure 102. Generation of the chemicurrent of this embodiment occurs not only through the adsorption of hydrogen or oxygen molecules, but also by exothermal events of recombination of intermediate products of the catalytic hydrogen oxidation on the Pd layer 108, such as H, O and OH, leading to the formation of water molecules. This is confirmed by mass-spectrometry measurements showing an increase of water vapor pressure in the vacuum chamber. FIG. 5 shows kinetics of H₂O partial pressure in the exhaust gas mixture for various surface temperatures. The contribution of the hydrogen oxidation in the chemicurrent generation becomes notable at temperatures around 480-500 K, as shown in FIG. 3. However, the chemicurrent generation through the hydrogen oxidation increases rapidly with further increases in the surface temperature, as shown in FIG. 3.

The generation of the chemicurrent of this embodiment can be explained within the following physical mechanism. A significant portion of the energy from the surface adsorption and recombination is absorbed by the phonon subsystem of the metal layer 108. As such, some of the electrons in the heated metal layer 108 will have energies sufficient to overcome the Schottky barrier, and participate in the thermionic (thermally driven) emission from the metal nanolayer 108 into the semiconductor substrate layer 110. A current density of this thermionic emission (jₜₕ) can be described by the Richardson's equation, jₜₕ=AT²Exp[−Φ/k_{B}T], where Φ is the Schottky barrier height, k_{B} and A are Boltzmann and effective Richardson constants.

Additionally, the gas-metal interface can provide a direct transfer of the chemical energy into the energy of excitation of electron subsystem of the metal, which represents the non-adiabatic channel of energy transfer. In such non-adiabatic hot electron generation, elementary exothermal chemical events on the metal surface 106 directly lead to the generation of additional hot electrons in the metal layer 108, and therefore to an additional (non-adiabatic, jₙₐ) generation of the chemicurrent.

The emission of the non-adiabatic hot electrons into the semiconductor layer 110 requires a thickness of the metal layer 108 to be smaller than a hot electron's mean free path λ. The λ value for most metals is on the order of tens of nanometers. As such, the Pd layer 108 is formed on the semiconductor layer 110 in a thickness between 7-25 nm, preferably between 8 nm-15 nm. The temperature dependency of the chemicurrent generation, as shown in FIG. 3, can be explained by a increase in rates of surface radical recombination and surface regeneration.

The chemicurrent density can be related to an internal quantum efficiency of the generator: (1) j=jₜₕ+jₙₐ=e (ηₜₕ+ηₙₐ) dN_{H2O}/dt; wherein ηₜₕ and ηₙₐ are internal quantum yields of hot electrons generated in the adiabatic and non-adiabatic events of the electron excitation in the catalytic metal layer 108; e is the elementary charge; and dN_{H2O}/dt is the rate of production of water molecules. The quantum yield is defined here as the mean number of hot electrons having sufficient energy to overcome the Schottky barrier, which are generated in the Pd/n-SiC heterojunction nanostructure 102 and collected by busbars in result of production of one water molecule on the metal surface 106. Using the relationship (1) along with the chemicurrent and mass-spectroscopy data of FIGS. 3 and 5, the total internal quantum yield (η) can be estimated: η=ηₜₕ+ηₙₐ.

FIG. 6 shows a temperature dependency of the total quantum yield (η). As shown, the quantum efficiency, which is also referred to as a quantum yield in this application, of the chemoelectrical power generator 100 exceeds 0.20 at a temperature of T=667 K. Such a value of η is much higher than those observed for the emission of hot electrons into vacuum, which implies a high potential of metal-semiconductor barrier layer nanostructures for the purpose of conversion of chemical energy into electric current. The power efficiency of chemoelectrical power generator 100 at given experimental settings can be estimated as the ratio of the input and output powers. The input power is defined by the rate of water molecules produced according to the mass-spectrometry data of FIG. 5 (2.22×10¹⁴ s⁻¹ at 667 K), multiplied by 4.74×10−19 J, the amount of energy released in the production of one water molecule from oxyhydrogen mixture; which equals 1.05×10⁻⁴ W. For the 10 k Ω load, the 7.2 μA chemicurrent at 667 K (FIG. 3) corresponds to 5.18×10⁻⁷ W output power, or 0.49% power efficiency. The power efficiency can be higher for impedance-matched loads.

To better quantify the contribution of the non-adiabatic current generation in the overall chemicurrent generation, the purely adiabatic (thermionic) current (i.e. thermocurrent) generated in vacuum by the Pd/n-SiC heterojunction nanostructure 102 only at the expense of heat received from an external electric heater was measured, as shown in FIG. 4. The difference between the total chemicurrent generated as shown by the curve 132 of FIG. 3, and the thermocurrent current generated as shown in FIG. 4, gives a magnitude of the non-adiabatically generated current. This analysis shows that the non-adiabatically generated current makes up about 75-85% of the total chemicurrent generated at a temperature between 550-700 K, and this fraction may further grow with temperature.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A chemovoltaic cell for converting a chemical energy to an electrical energy comprising:
a semiconductor layer;
a catalyst metal layer attached to the semiconductor layer, wherein a junction between the catalyst metal layer and the semiconductor layer provides a Schottky contact;
a metallic layer attached to the semiconductor layer providing an Ohmic contact;
wherein the catalyst metal layer catalyzes a chemical reaction on a surface of the catalyst metal layer to generate a chemical energy; and
wherein a combination of the catalyst metal layer, the semiconductor layer and the metallic layer converts the chemical energy into an electrical energy.

2. The chemovoltaic cell of claim 1, wherein the chemical reaction is a hydrogen oxidation.

3. The chemovoltaic cell of claim 1, further including a chamber comprising an inlet and an outlet; wherein the inlet receives a molecular hydrogen and oxygen or air, wherein the catalyst metal layer catalyzes 2H₂+O₂→2H₂O reaction producing the chemical energy and a water vapor, wherein the outlet allows the water vapor to flow out from the chamber.

4. The chemovoltaic cell of claim 1, wherein the catalyst metal layer and the semiconductor layer forms a Schottky barrier, wherein the catalyst metal layer generates and emits hot electrons using the chemical energy, wherein the hot electrons travel over the Schottky barrier to generate an electrical current.

5. The chemovoltaic cell of claim 1, wherein the chemical reaction is an exothermic reaction and the chemical energy released from the exothermic reaction generates adiabatic hot electrons and non-adiabatic hot electrons in the catalyst metal layer.

6. The chemovoltaic cell of claim 5, wherein the adiabatic hot electrons and the non-adiabatic hot electrons travel over a Schottky barrier at the Schottky contact to generate an electrical current, wherein over 70% of the electric current is generated from the non-adiabatic hot electrons.

7. The chemovoltaic cell of claim 1, wherein the semiconductor is n-type.

8. The chemovoltaic cell of claim 1, wherein the semiconductor is p-type.

9. The chemovoltaic cell of claim 1, wherein the catalyst metal layer has a thickness of between 7 nm-25 nm.

10. The chemovoltaic cell of claim 9, wherein the catalyst metal layer is formed of Pt, wherein the catalyst metal layer has a thickness between 7 nm-10 nm.

11. The chemovoltaic cell of claim 9, wherein the catalyst metal layer is formed of Pd, wherein the catalyst metal layer has a thickness between 8 nm-15 nm.

12. The chemovoltaic cell of claim 9, wherein the catalyst metal layer is formed of Ni, wherein the catalyst metal layer has a thickness between 8 nm-15 nm.

13. The chemovoltaic cell of claim 9, wherein the catalyst metal layer is formed of Ag, wherein the catalyst metal layer has a thickness between 10 nm-25 nm.

14. The chemovoltaic cell of claim 9, wherein the catalyst metal layer is formed of Au, wherein the catalyst metal layer has a thickness between 10 nm-25 nm.

15. The chemovoltaic cell of claim 1, wherein the semiconductor layer has a first surface and a second surface, wherein the catalyst metal layer is formed on the first surface and the metallic layer is formed on the second surface such that the semiconductor layer is placed between the catalyst metal layer and the metallic layer.

16. The chemovoltaic cell of claim 1, wherein the catalyst metal layer is formed of Pd, the catalyst metal layer having a thickness between 8 nm-15 nm; wherein the semiconductor layer is formed of an n-type of SiC-6H; wherein the metallic layer is formed of In; wherein the surface of the catalyst metal layer receives a stoichiometric oxyhydrogen mixture and catalyzes a 2H₂+O₂→2H₂O reaction to generate the chemical energy; wherein the chemovoltaic cell has a quantum yield of about 0.20.

17. The chemovoltaic cell of claim 1, wherein the catalyst metal layer and the metallic layer are formed on a same surface of the semiconductor layer.

18. A method of converting a chemical energy into an electrical energy, comprising:
providing a chemovoltaic cell, the chemovoltaic cell comprising:
a semiconductor layer;
a catalyst metal layer on the semiconductor layer providing a Schottky barrier;
a metal layer on the semiconductor layer providing an Ohmic contact;
supplying reactants on a surface of the catalyst metal layer;
catalyzing a chemical reaction of the reactants using the catalyst metal layer to generate a chemical energy;
energizing electrons in the catalyst metal layer using the chemical energy to generate hot electrons; and
emitting hot electrons from the catalyst metal layer toward the semiconductor layer over the Schottky barrier to generate an electrical current.

19. The method of claim 18, wherein said supplying reactants includes providing a stoichiometric oxyhydrogen mixture such that the stoichiometric oxyhydrogen mixture comes in contact with the catalyst metal layer, wherein said catalyzing includes facilitating a hydrogen oxidation reaction of the stoichiometric oxyhydrogen mixture using the catalyst metal layer.

20. The method of claim 18, wherein said providing a chemovoltaic cell includes forming the semiconductor layer comprising an n-type SiC-6H substrate having a polished side and a nonpolished side, depositing a continuous layer of Pd on the polished side of the semiconductor layer to form the catalyst metal layer having a thickness between 8 nm-15 nm, and infusing In on the nonpolished side of the semiconductor layer to form the metal layer.

21. The method of claim 20, further comprising placing the chemovoltaic cell in a vacuum chamber; wherein supplying reactants include providing a stochiometric oxhydrogen mixture into the vacuum chamber in an amount of at least 0.05 Torr at a temperature between about 600K-700K to generate the hot electrons at a quantum yield of about 0.2, wherein the quantum yield is a mean number of hot electrons having sufficient energy to overcome the Schottky barrier per production of one water molecule from the hydrogen oxidation reaction.

22. The method of claim 18, wherein said catalyzing includes facilitating an exothermic chemical reaction, wherein said energizing electrons include using the chemical energy released from the exothermic chemical reaction to generate the hot electron adiabatically and non-adiabatically, wherein at least a portion of chemical energy is directly transferred into an energy of excitation of electron subsystem of the catalyst metal layer to generate the hot electrons non-adiabatically.

23. The method of claim 22, wherein said energizing electrons includes generating at least 70% of the hot electrons non-adiabatically by direct transfer of chemical energy into the energy of excitation of the hot electrons.

24. A method of generating electrical energy, comprising:
providing a chemovoltaic cell comprising a catalyst metal layer and a metal layer on a semiconductor layer;
supplying a molecular hydrogen and oxygen on the catalyst metal layer;
catalyzing a 2H₂+O₂→2H₂O reaction of the molecular hydrogen and oxygen to produce a chemical energy using the catalyst metal layer; and
emitting hot electrons in the catalyst metal layer induced by the chemical energy over a Schottky barrier formed by the catalyst layer and the semiconductor layer.

25. The method of claim 24, wherein said providing chemovoltaic cell includes depositing a catalyst metal layer on a surface of the semiconductor layer in a thickness between 7 nm-25 nm.

26. The method of claim 24, further including generating electrical energy at a quantum yield of about 0.2 at an operating temperature of about 667K.

27. A chemovoltaic battery, comprising:
a chamber having a gas inlet and a gas outlet;
a plurality of chemovoltaic cells arranged in the chamber, wherein each of the plurality of chemovoltaic cells comprising:
a semiconductor layer;
a catalyst metal layer attached to the semiconductor layer, wherein a junction between the catalyst metal layer and the semiconductor layer provides a Schottky barrier;
a metallic layer attached to the semiconductor layer providing an Ohmic contact; and
wherein the catalyst metal layer catalyzes a chemical reaction and emits hot electrons.

28. The chemovoltaic battery of claim 27, wherein the gas inlet delivers a molecular hydrogen and oxygen or air into the chamber, wherein the catalyst metal layer catalyzes a hydrogen oxidation reaction of the molecular hydrogen and oxygen to generate a chemical energy, wherein the catalyst metal layer generates and emits the hot electrons using the chemical energy.

29. The chemovoltaic battery of claim 27, wherein the catalyst metal layer has a thickness between 7 nm-25 nm, the catalyst metal layer formed of Ni, Pd, Pt, Au, Ag, or Ir.

30. The chemovoltaic battery of claim 27, wherein the catalyst metal layer generates hot electrons using the chemical energy, wherein the catalyst metal layer generates at least 70% of the hot electrons non-adiabatically.

31. A chemoelectrical power generator comprising:
an n-type chemovoltaic cell including a first catalyst metal layer and a first metal layer on an n-type semiconductor layer;
a p-type chemovoltaic cell including a second catalyst metal layer and a second metal layer on a p-type semiconductor layer;
a junction connecting the n-type chemovoltaic cell and p-type chemovoltaic cell;
wherein the first catalyst metal layer and the second catalyst metal layer catalyze a hydrogen oxidation reaction to produce a chemical energy; and
wherein a combination of the n-type chemovoltaic cell and the p-type chemovoltaic cell converts the chemical energy into an electrical energy.
